(19) United States
(12) Patent Application Publication
(10) Pub. No.: US 2007/0160300 A1
(43) Pub. Date: Jul. 12, 2007

(54) Spatial scalable compression scheme with a dead zone

(75) Inventors: Henricus Antonius Gerardus Van Vugt, Eindhoven (NL); Wilhelmus Hendrikus Alfonsus Bruls, Eindhoven (NL); Gerardus Johannes Maria Vervoort, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,134

(22) PCT Filed: Nov. 29, 2004
(86) PCT No.: PCT/IB04/52583

§ 371 Date: Jun. 1, 2006

(30) Foreign Application Priority Data
Dec. 8, 2003 (EP) 03104588.3

(51) Int. Cl. G06K 9/46; G06K 9/40

(52) U.S. Cl. 382/240; 382/260

(57) ABSTRACT

An apparatus is disclosed for performing spatial scalable compression of video information captured in a plurality of frames including an encoder for encoding and outputting the captured video frames into a compressed data stream, comprising a base layer comprising an encoded bitstream having a relatively low resolution, a high resolution enhancement layer comprising a residual signal having a relatively high resolution, and wherein a dead zone operation unit attenuates the residual signal, the residual signal being the difference between the original frames and the upscaled frames from the base layer. As a result, the number of bits needed for the compressed data stream is reduced for a given observed video quality.

The invention relates to a video encoder/decoder, and more particularly to a video encoder/decoder with a spatial scalable compression scheme. The invention further relates to an apparatus for performing spatial scalable compression of video information and to a method for providing spatial scalable compression of a video stream.

Because of the massive amounts of data inherent in digital video, the transmission of full-motion, high-definition digital video signals is a significant problem in the development of high-definition television. More particularly, each digital image frame is a still image formed from an array of pixels according to the display resolution of a particular system. As a result, the amounts of raw digital information included in high-resolution video sequences are massive. In order to reduce the amount of data that must be sent, compression schemes are used to compress the data. Various video compression standards or processes have been established, including, MPEG-2, MPEG-4, and H.263.

Many applications are enabled where video is available at various resolutions and/or qualities in one stream. Methods to accomplish this are loosely referred to as scalability techniques. There are three axes on which one can deploy scalability. The first is scalability on the time axis, often referred to as temporal scalability. Secondly, there is scalability on the quality axis (quantization), often referred to as signal-to-noise (SNR) scalability or fine-grain scalability. The third axis is the resolution axis (number of pixels in image) often referred to as spatial scalability. In layered coding, the bitstream is divided into two or more bitstreams, or layers. Each layer can be combined to form a single high quality signal. For example, the base layer may provide a lower quality video signal, while the enhancement layer provides additional information that can enhance the base layer image.

In particular, spatial scalability can provide compatibility between different video standards or decoder capabilities. With spatial scalability, the base layer video may have a lower resolution than the input video sequence, in which case the enhancement layer carries information which can restore the resolution of the base layer to the input sequence level.

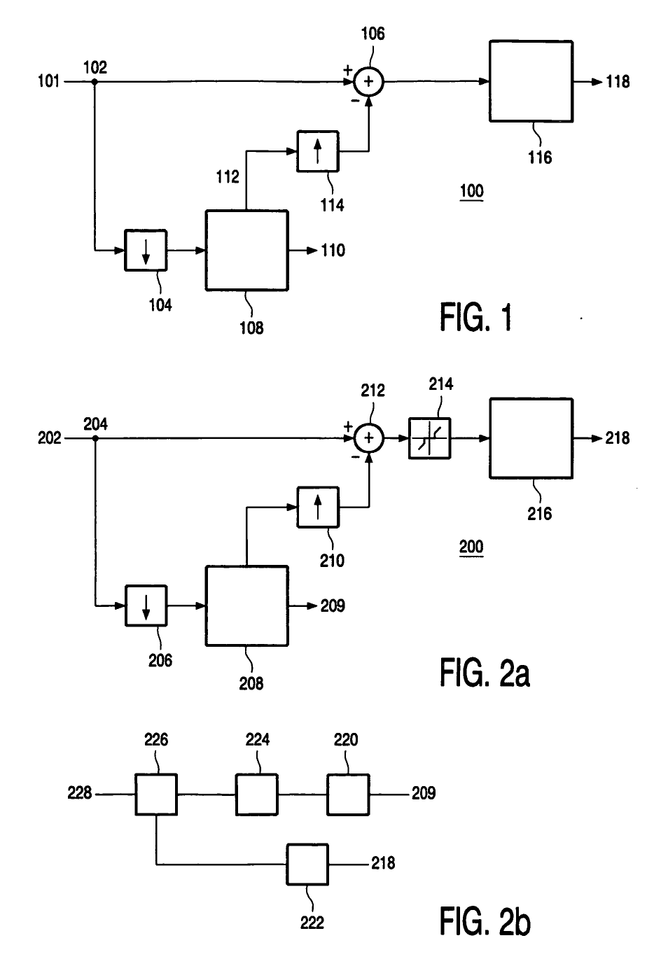

FIG. 1 illustrates a known spatial scalable video encoder 100. The depicted encoding system 100 accomplishes layer compression, whereby a portion of the channel is used for providing a low resolution base layer and the remaining portion is used for transmitting edge enhancement information, whereby the two signals may be recombined to bring the system up to high-resolution. The high resolution video input 101 is split by splitter 102 whereby the data is sent to a low pass filter 104 and a subtraction circuit 106. The low pass filter 104 reduces the resolution of the video data, which is then fed to a base encoder 108. In general, low pass filters and encoders are well known in the art and are not described in detail herein for purposes of simplicity. The encoder 108 produces a lower resolution base stream 110 which can be broadcast, received and via a decoder, displayed as is, although the base stream does not provide a resolution which would be considered as high-definition.

The output of the encoder 108 is also fed to a decoder 112 within the system 100. From there, the decoded signal is fed into an interpolate and upsample circuit 114. In general, the interpolate and upsample circuit 114 reconstructs the filtered out resolution from the decoded video stream and provides a video data stream having the same resolution as the high-resolution input. However, because of the filtering and the losses resulting from the encoding and decoding, loss of information is present in the reconstructed stream. The loss is determined in the subtraction circuit 106 by subtracting the reconstructed high-resolution stream from the original, unmodified high-resolution stream. The output of the subtraction circuit 106 is fed to an enhancement encoder 116 which outputs a reasonable quality enhancement stream 118.

Although these layered compression schemes can be made to work quite well, these schemes still have a problem in that the enhancement layer needs a high bitrate. Normally, the bitrate of the enhancement layer is equal to or higher than the bitrate of the base layer. However, the desire to store high definition video signals calls for lower bitrates than can normally be delivered by common compression standards. This can make it difficult to introduce high definition on existing standard definition systems, because the recording/playing time becomes too small.

The invention overcomes at least part of the deficiencies of other known layered compression schemes by using a dead zone operation to reduce the number of bits in the residual signal inputted into the enhancement encoder, thereby lowering the bitrate of the enhancement layer.

According to one embodiment of the invention, a method and apparatus for performing spatial scalable compression of video information captured in a plurality of frames including an encoder for encoding and outputting the captured video frames into a compressed data stream is disclosed. A base layer comprises an encoded bitstream having a relatively low resolution. A high resolution enhancement layer comprises a residual signal having a relatively high resolution. A dead zone operation unit attenuates the residual signal, wherein the residual signal being the difference between the original frames and the upscaled frames from the base layer. As a result, the number of bits needed for the compressed data stream is reduced for a given observed video quality.

According to another embodiment of the invention, a method and apparatus for providing spatial scalable compression using adaptive content filtering of a video stream is disclosed. The video stream is downsampled to reduce the resolution of the video stream. The downsampled video stream is encoded to produce a base stream. The base stream is decoded and upconverted to produce a reconstructed video stream. The reconstructed video stream is subtracted from the video stream to produce a residual stream. The residual stream is attenuated using a dead zone operation to remove bits from the residual stream. The resulting residual stream is encoded and outputted as an enhancement stream.

These and other aspects of the invention will be apparent from and elucidated with reference to the embodiments described hereafter.

The invention will now be described, by way of example, with reference to the accompanying drawings, wherein:

FIG. 1 is a block diagram representing a known layered video encoder;

FIGS. 2(a)-(b) are a block diagram of a layered video encoder/decoder according to one embodiment of the invention;

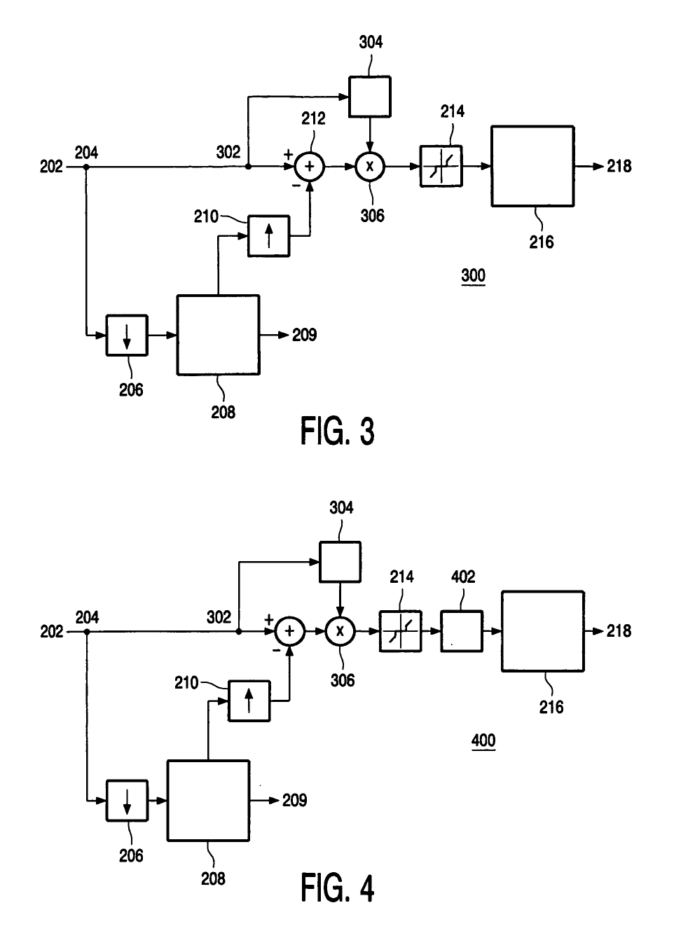

FIG. 3 is a block diagram of a layered video encoder according to one embodiment of the invention;

FIG. 4 is a block diagram of a layered video encoder according to one embodiment of the invention;

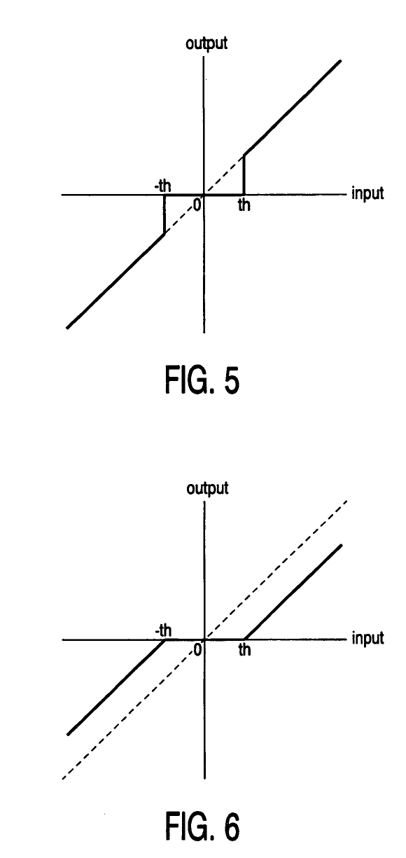

FIG. 5 illustrates a dead zone method according to one embodiment of the invention;

FIG. 6 illustrates a dead zone method according to one embodiment of the invention;

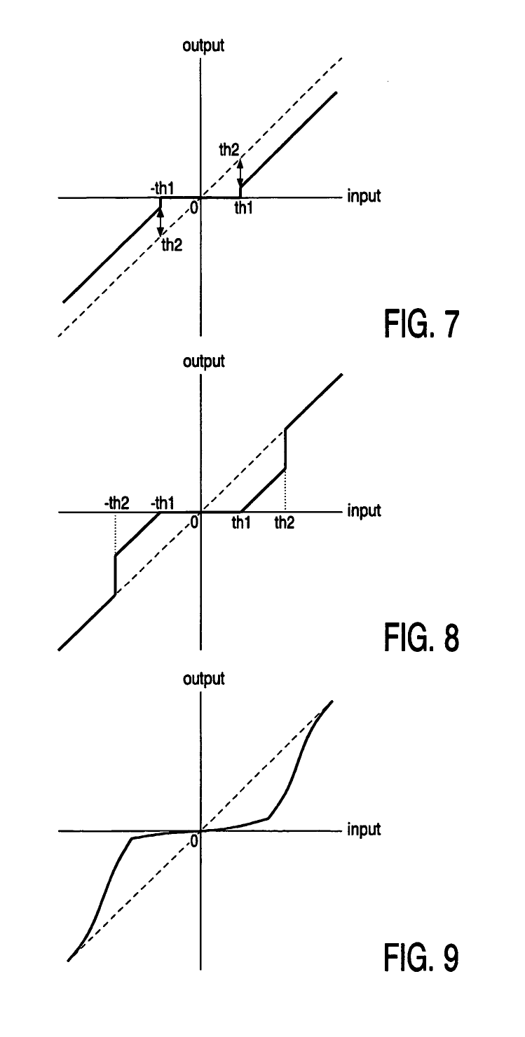

FIG. 7 illustrates a dead zone method according to one embodiment of the invention;

FIG. 8 illustrates a dead zone method according to one embodiment of the invention;

FIG. 9 illustrates a dead zone method according to one embodiment of the invention;

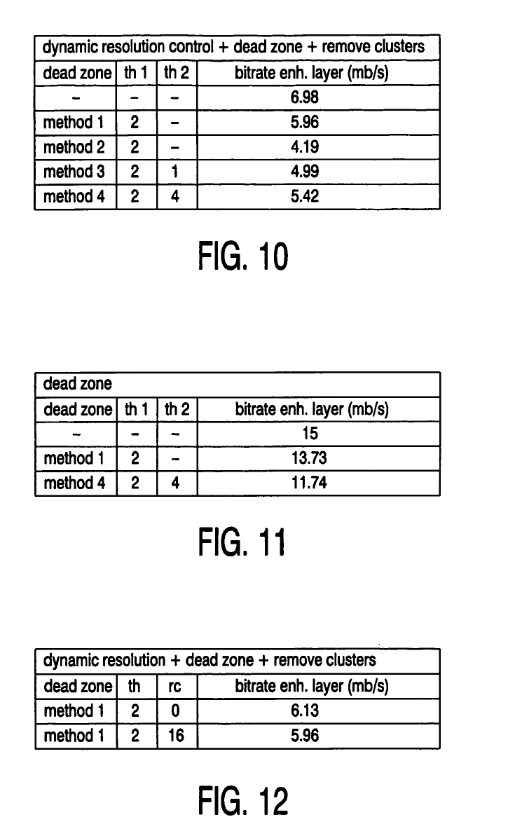

FIGS. 10-12 illustrate results of different dead zone methods according to embodiments of the invention.

FIGS. 2(a)-(b) are a block diagram of a layered video encoder/decoder 200 according to one embodiment of the invention. The encoder/decoder 200 comprises an encoding section 201 and a decoding section. A high-resolution video stream 202 is inputted into the encoding section 201. The video stream 202 is then split by a splitter 204, whereby the video stream is sent to a low pass filter 206 and a subtraction unit 212. The low pass filter or downsampling unit 206 reduces the resolution of the video stream, which is then fed to a base encoder 208. The base encoder 208 encodes the downsampled video stream in a known manner and outputs a base stream 209. In this embodiment, the base encoder 208 outputs a local decoder output to an upconverting unit 210. The upconverting unit 210 reconstructs the filtered out resolution from the local decoded video stream and provides a reconstructed video stream having basically the same resolution format as the high-resolution input video stream in a known manner. Alternatively, the base encoder 208 may output an encoded output to the upconverting unit 210, wherein either a separate decoder (not illustrated) or a decoder provided in the upconverting unit 210 will have to first decode the encoded signal before it is upconverted.

As mentioned above, the reconstructed video stream and the high-resolution input video stream are inputted into the subtraction unit 212. The subtraction unit 212 subtracts the reconstructed video stream from the input video stream to produce a residual stream. A dead zone operation is then applied to the residual stream in the dead zone operation unit 214. A dead zone operation is a non-linear operation where a smaller input receives a larger attenuation and a larger input receives a gradually smaller attenuation (can also be seen as a linear combination of several dead zone operations, and a linear transform function). A plurality of different dead zone operations are described below, but it will be understood by those skilled in the art that any dead zone operation can be used in the present invention and the invention is not limited thereto. The result of the dead zone operation is that small values of the residual signal will be clipped to zero which leads to somewhat less information in the picture. As a result, a higher compression efficiency can be achieved without a perceptive loss of picture quality. The output from the dead zone operation unit 214 is inputted into the enhancement encoder 216 which produces an enhancement stream 218.

In the decoder section 205, the base stream 209 is decoded in a known manner by a decoder 220 and the enhancement stream 218 is decoded in a known manner by a decoder 222. The decoded base stream is then upconverted in an upconverting unit 224. The upconverted base stream and the decoded enhancement stream are then combined in an arithmetic unit 226 to produce an output video stream 228.

FIG. 3 illustrates an encoder 300 according to another embodiment of the invention. In this embodiment, a picture analyzer 304 has been added to the encoder illustrated in FIG. 2. A splitter 302 splits the high-resolution input video stream 202, whereby the input video stream 202 is sent to the subtraction unit 212 and the picture analyzer 304. In addition, the reconstructed video stream is also inputted into the picture analyzer 304 and the subtraction unit 212. The picture analyzer 304 analyzes the frames of the input stream and/or the frames of the reconstructed video stream and produces a numerical gain value of the content of each pixel or group of pixels in each frame of the video stream. The numerical gain value is comprised of the location of the pixel or group of pixels given by, for example, the x,y coordinates of the pixel or group of pixels in a frame, the frame number, and a gain value. When the pixel or group of pixels has a lot of detail, the gain value moves toward a maximum value of “1”. Likewise, when the pixel or group of pixels does not have much detail, the gain value moves toward a minimum value of “0”. Several examples of detail criteria for the picture analyzer are described below, but the invention is not limited to these examples. First, the picture analyzer can analyze the local spread around the pixel versus the average pixel spread over the whole frame. The picture analyzer could also analyze the edge level, e.g., abs of -1-1-1
-1 8-1
-1-1-1
   per pixel divided over average value over whole frame.

The gain values for varying degrees of detail can be predetermined and stored in a look-up table for recall once the level of detail for each pixel or group of pixels is determined.

As mentioned above, the reconstructed video stream and the high-resolution input video stream are inputted into the subtraction unit 212. The subtraction unit 212 subtracts the reconstructed video stream from the input video stream to produce a residual stream. The gain values from the picture analyzer 304 are sent to a multiplier 306 which is used to control the attenuation of the residual stream. In an alternative embodiment, the picture analyzer 304 can be removed from the system and predetermined gain values can be loaded into the multiplier 306. The effect of multiplying the residual stream by the gain values is that a kind of filtering takes place for areas of each frame that have little detail. In such areas, normally a lot of bits would have to be spent on mostly irrelevant little details or noise. But by multiplying the residual stream by gain values which move toward zero for areas of little or no detail, these bits can be removed from the residual stream before being encoded in the enhancement encoder 216. Likewise, the multipler will move toward one for edges and/or text areas and only those areas will be encoded. The effect on normal pictures can be a large saving on bits. Although the quality of the video will be effected somewhat, in relation to the savings of the bitrate, this is a good compromise especially when compared to normal compression techniques at the same overall bitrate. The output of the multiplier 306 is then supplied to the dead zone operation unit 214. As mentioned above, the dead zone operation unit 214 performs a dead zone operation so that small values of the stream from the multiplier 306 are clipped to zero. The output from the dead zone operation unit 214 is inputted into the enhancement encoder 216 which produces an enhancement stream 218.

FIG. 4 illustrates an encoder 400 according to another embodiment of the invention. In this embodiment, a “remove clusters” operation is added to the encoder illustrated in FIG. 3. It will be understood that the remove cluster operation could also be performed after the dead zone operation in the encoder illustrated in FIG. 2. To improve the coding efficiency even more, a remove cluster operation unit 402 is added after the dead zone operation unit 214. The remove cluster operation removes single pixels within a certain range. Since these single pixels do not contribute to the sharpness of the picture, these pixels can be removed without a perceptive picture quality loss.

The remove cluster operation works as follows. First there is an operation which passes only the important residual pixels and makes all other residual pixels zero. Examples of such operations are content adaptive attenuation and/or deadzone. The residual image now consists of a collection of clusters, wherein a cluster is a group of pixels completely surrounded by pixels with a value of zero. The next step is to determine the length (value) of the perimeter of each cluster of non-zero residual pixels. If this value is below a certain threshold, then all pixel values of the corresponding cluster are forced to zero as well. Alternatively, instead of determining the perimeter value for a cluster, the number of non-zero pixels in each cluster can be determined, wherein clusters which have fewer than a predetermined number of pixels are forced to zero.

FIG. 5 illustrates a dead zone method according to one embodiment of the invention. In this embodiment, a threshold value th is selected by the user, designer, or could even be content adaptive as illustrated in FIG. 3. The dead zone operation unit 214 then clips pixel values which are smaller than the threshold th to zero. As a result, there are fewer pixels in the residual stream which need to be encoded.

FIG. 6 illustrates a dead zone method according to one embodiment of the invention. This dead zone operation clips values smaller than the threshold th to zero. Additionally, this method subtracts the threshold th from all other values in the residual stream. This results in an error of th pixels for every pixel. Due to this extra reduction of the value of the other pixels, an extra compression efficiency is obtained at the cost of a small but noticeable picture quality loss.

FIG. 7 illustrates a dead zone method according to one embodiment of the invention. This dead zone operation is obtained by cascading the dead zone methods illustrated in FIGS. 5 and 6. This dead zone operation clips values smaller than the threshold th1 to zero. Additionally, this method subtracts a threshold value th2 from all other values in the residual stream. This results in an error of th2 pixels for every larger pixel. The advantage of this method compared to the method illustrated in FIG. 6 is that the error for the pixels above the threshold th1 is smaller using this method.

FIG. 8 illustrates a dead zone method according to one embodiment of the invention. This dead zone method clips all values smaller than the threshold th1 to zero. From every pixel between the threshold th1 and threshold th2, the value of th1 is subtracted. For every pixel above the threshold th2, the output is the same as the input. This way an extra compression efficiency can be obtained, with only an error of th1 pixels for a limited number of pixels.

FIG. 9 illustrates a more generic dead zone method according to one embodiment of the invention. Instead of using discrete steps as is done in the above-described methods, a more generic solution is to use a lookup table. This lookup table contains output values for all possible input values. This way any transfer curve is possible.

The different dead zone methods described above have been compared and the results of the comparison are provided below. As an input, a 50 frame 1080p, 24 Hz sequence was used. This sequence was encoded using MPEG-2 for the standard definition (720×480) base layer and MPEG-2 for the high definition (1920×1080) enhancement layer. A coding scheme with dynamic resolution control and a remove clusters operation, as illustrated in FIG. 4, was used. The results of this comparison are illustrated in FIG. 10. The resulting quality for method 1 is very good compared to the result without a dead zone operation. With methods 2 and 3, some loss of resolution can be clearly noticed. With method 4, some resolution loss can still be noticed, but this is less than the loss in methods 2 and 3 and this method seems to be a good compromise between method 1 and methods 2 and 3.

FIG. 11 illustrates some results for a dead zone operation without the use of additional dynamic resolution control or the remove clusters operation. This coding scheme is illustrated in FIG. 2. These are added as a reference to see the effect of the dead zone operation without dynamic resolution control and remove clusters operation. To see the effect of the remove clusters operation, the above mentioned sequence has been encoded with and without the remove clusters operation being used. The dynamic resolution control and dead zone method 1 were also used. The results are illustrated in FIG. 12.

The above-described embodiments of the invention enhance the efficiency of known spatial scalable compression schemes by lowering the bitrate of the enhancement layer by using dead zone operations, dynamic resolution control, and/or remove clusters operations to remove unnecessary bits from the residual stream prior to encoding. It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims. Additionally, although individual features may be included in different claims, these may possibly be advantageously combined, and the inclusion in different claims does not imply that a combination of features is no feasible and/or advantageous.

1. An apparatus for performing spatial scalable compression of video information captured in a plurality of frames including an encoder for encoding and outputting the captured video frames into a compressed data stream, comprising:
a base layer (201) comprising an encoded bitstream having a relatively low resolution;
a high resolution enhancement layer (203) comprising a residual signal having a relatively high resolution; and
wherein a dead zone operation unit (214) attenuates the residual signal, the residual signal being the difference between the original frames and the upscaled frames from the base layer.

2. The apparatus for performing spatial scalable compression of video information according to claim 1, wherein the dead zone operation unit attenuates the residual signal by clipping pixel values below a first threshold value to zero.

3. The apparatus for performing spatial scalable compression of video information according to claim 1, wherein the dead zone operation unit attenuates the residual signal by clipping pixel values below a first threshold value to zero and subtracting the first threshold value from all other pixel values.

4. The apparatus for performing spatial scalable compression of video information according to claim 1, wherein the dead zone operation unit attenuates the residual signal by clipping pixel values below a first threshold value to zero and subtracting a second threshold value from all other pixel values.

5. The apparatus for performing spatial scalable compression of video information according to claim 1, wherein the dead zone operation unit attenuates the residual signal by clipping pixel values below a first threshold value to zero and subtracting the first threshold value from pixel values between the first threshold value and a second threshold value.

6. The apparatus for performing spatial scalable compression of video information according to claim 1, wherein the dead zone operation unit attenuates the residual signal by using a lookup table to produce an output value for each input value.

7. The apparatus for performing spatial scalable compression of video information according to claim 1, further comprising:
a picture analyzer (304) which receives upscale and/or original frames and calculates a gain value of the content of each pixel in each received frame, wherein the multiplier uses the gain value to attenuate the residual signal prior to being inputted into the dead zone operation unit.

8. The apparatus for performing spatial scalable compression of video information according to claim 7, wherein the gain value goes toward zero for areas of little detail.

9. The apparatus for performing spatial scalable compression of video information according to claim 7, wherein the gain value goes toward one for edges and text areas.

10. The apparatus for performing spatial scalable compression of video information according to claim 7, wherein the gain value is calculated for a group of pixels.

11. The apparatus for performing spatial scalable compression of video information according to claim 1, further comprising:
a remove clusters operation unit (402) for removing residual pixels belonging to a pixel cluster for clusters below a predetermined size from the residual output.

12. The apparatus for performing spatial scalable compression of video information according to claim 11, wherein the size is the perimeter value of each cluster.

13. The apparatus for performing spatial scalable compression of video information according to claim 11, wherein the size is the number of non-zero pixels in each cluster.

14. A layered encoder for encoding and decoding a video stream, comprising:
a downsampling unit (206) for reducing the resolution of the video stream;
a base encoder (208) for encoding a lower resolution base stream;
an upconverting unit (210) for decoding and increasing the resolution of the base stream to produce a reconstructed video stream;
a subtractor unit (212) for subtracting the reconstructed video stream from the original video stream to produce a residual signal;
a dead zone operation unit (214) which attenuates the residual signal;
an enhancement encoder (216) for encoding the resulting residual signal from the dead zone operation unit and outputting an enhancement stream.

15. The layered encoder according to claim 14, further comprising:
a picture analyzer (304) which receives the video stream and the reconstructed video stream and calculates the gain values of the content of each pixel in each frame of the received streams; and
a first multiplier unit (306) which multiplies the residual signal by gain values so as to remove bits from the residual signal for areas which have little detail.

16. A method for providing spatial scalable compression using adaptive content filtering of a video stream, the method comprising the steps of:
downsampling the video stream to reduce the resolution of the video stream;
encoding the downsampled video stream to produce a base stream;
decoding and upconverting the base stream to produce a reconstructed video stream;
subtracting the reconstructed video stream from the video stream to produce a residual stream;
attenuating the residual stream using a dead zone operation to remove bits from the residual stream; and
encoding the resulting residual stream and outputting an enhancement stream.

17. The method for providing spatial scalable compression using adaptive content filtering of a video stream according to claim 16, the method further comprising the steps of:
analyzing the video stream and the reconstructed video stream to produce gain values of the content of each pixel in the frames of the received video streams; and
multiplying the residual stream by gain values so as to remove bits from the residual stream prior to the dead zone operation.

18. The method for providing spatial scalable compression using adaptive content filtering of a video stream according to claim 16, the method further comprising the step of:
removing residual pixels belonging to a pixel cluster for clusters below a predetermined size from the residual output.
